(19) United States
(12) Patent Application Publication
(10) Pub. No.: US 2024/0071252 A1
(43) Pub. Date: Feb. 29, 2024

(54) CHEMISTRY CALCULATORS

(71) Applicant: Gordon Leonard Pettus, Vista, CA (US)

(72) Inventor: Gordon Leonard Pettus, Vista, CA (US)

(21) Appl. No.: 17/899,309

(22) Filed: Aug. 30, 2022

(51) Int. Cl. G09B 23/24

(52) U.S. Cl. CPC G09B 23/24

(57) ABSTRACT

A system and method are provided for solving chemistry problems and performing related processes with the implementation of computer-based technologies. This is done using non-graphic input data for a computer. More particularly, a Graphical User Interface (GUI) is provided for selecting the non-graphical input data that is pertinent for compliance with preprogrammed chemistry equations, chemical processes, and operational environments. With this input data the computer will generate the non-graphical output data that is needed to create a graphical display of solutions from the chemistry equations for teaching and information purposes.

### FIELD OF THE INVENTION

The present invention pertains to systems and methods for performing computations of chemistry problems and performing related processes. More particularly, the present invention is directed to the implementation of computer-based technologies that use non-graphic input data to solve chemistry problems and perform chemical processes. The present invention is particularly, but not exclusively useful as a Graphical User Interface (GUI) that provides a user with the means for selecting non-graphical input data pertinent to chemistry problems, chemical processes, and operational environments with which the computer will calculate non-graphical output data needed to create a graphical display of solutions for analytical, teaching, and information purposes.

### BACKGROUND OF THE INVENTION

Computers are versatile tools that are adaptable for many different purposes. Of special interest here is a computer's problem-solving ability for a plethora of different purposes in the general field of chemistry. Specifically, a computer's ability to simultaneously handle and process a variety of non-graphical input data is important. Also, the flexibility with which a computer can manipulate input data to achieve and evaluate solutions for chemical problems is helpful.

In general, the result of every chemical reaction is determined by its compliance with a balanced chemical equation in accordance with the performance of a related process. Depending on the nature and quantity of substances to be used for a reaction, and the requirements of the process to be performed, many different results are possible. Of particular importance for the present invention is the ability and flexibility with which chemistry equations can be solved and thereafter used and/or evaluated. A computer-based tool for doing this can be helpful for many reasons.

With the above in mind, it is an object of the present invention to perform standard chemistry calculations with easily selected units and processes as input values. Another object of the present invention is to provide a graphical view of multi-substance processes in a natural, organized way. Still another object of the present invention is to provide a record of the computer's calculations and an explanation of the results. Yet another object of the present invention is to provide a system and method for performing standard chemistry calculation that are easy to be computer-programmed, is simple to use, and is comparatively cost effective.

### SUMMARY OF THE INVENTION

A Graphical Unit Interface (GUI) is provided by the present invention to facilitate a user's calculations for chemical equations and to provide him/her with a brief explanation of the process that results from a reaction of substances in the equation. The focus of the present invention is directed primarily to the facilitation of calculations required for the solution of equations that describe common, well-known chemical reactions and processes. Specifically, the present invention is useful for calculating solutions when the chemical reactions can be performed in different environments or for different purposes. Simply stated, the present invention is directed to electronic systems that will quickly calculate solutions for balanced chemical equations which could otherwise be very time-consuming and subject to human error.

A system for the present invention includes a computer which is programmed to balance and solve predetermined chemical equations involving substances of chemical compounds. As envisioned for the present invention, a single substance can be considered individually, or a plurality of substances can be considered collectively. In either case, calculations for a chemical equation are made that will exemplify and describe the chemical process(es) being performed for the resultant reaction(s). Moreover, with the GUI, a user can identify an environment of interest for the equations and the processes. These environments will typically be selected from i) a laboratory environment for experimental purposes, ii) an industrial environment for commercial purposes, and iii) a natural environment for discovery purposes.

As appreciated by the present invention, calculations for chemical equations will differ significantly depending on the chemical process(es) that is(are) involved. Accordingly, to further simplify calculations, the present invention differentiates processes as being either a minor process or a major process. In detail, a minor process will involve calculations for a single substance and will typically result in establishing a molarity or molality for the substance. On the other hand, a major process will involve a plurality of substances and require balancing equations, evaluating combustion, and producing a synthesis with the plurality of substances.

The system of the present invention also includes a calculator which is electronically connected with the computer. For this combination of components, the GUI is incorporated with the calculator as a graphical chart which interfaces with the computer. With the GUI, a user is thereby able to provide input data instructions to the computer for solving the chemical equations and for performing the related processes. An important feature of the GUI is that the graphical chart will visually prompt a user to provide the necessary instructions for initiating a system operation.

In detail, the graphical chart of the GUI is presented as two sections. A first section is used for sending instructions from the user to the computer for its operation. Typically, these instructions will include selecting at least one substance. Also, the instructions will include directions for balancing a chemical equation, if necessary, and for selecting a minor/major process for execution by the computer. The instructions may further include identifying an environment of interest for the substance and the process.

A second section of the graphical chart is provided for inputting non-graphical values pertinent to substances in the chemical equation(s). Units and quantities for the substances that are to be used by the computer for calculating solutions to the equations for the selected process(es) are also included. The computer will then calculate non-graphical output data for a solution(s) of chemical equation(s). This non-graphical output data will then be used for display as graphical data in an organized graphical presentation on the second section of the graphical chart. For purposes of the present invention the term “graphical” means a visual image of alphanumeric data arranged and displayed to emphasize a relationship between chemical substances. On the other hand, “non-graphical” data is alphanumeric data which is stand-alone, and unarranged for display.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a Graphical User Interface (GUI) being held by a user;

FIG. 2 is a schematic view of the components in a system for a computerized calculator in accordance with the present invention;

FIG. 3 is a diagram showing the interactive flow of input/output non-graphical data between the GUI of the present invention and a computer; and

FIG. 4 is a presentation of the graphical chart employed by the GUI for showing non-graphical output data from the computer as graphical data on the graphical chart in an organized manner.

### DESCRIPTION OF THE PREFERRED EMBODIMENTS

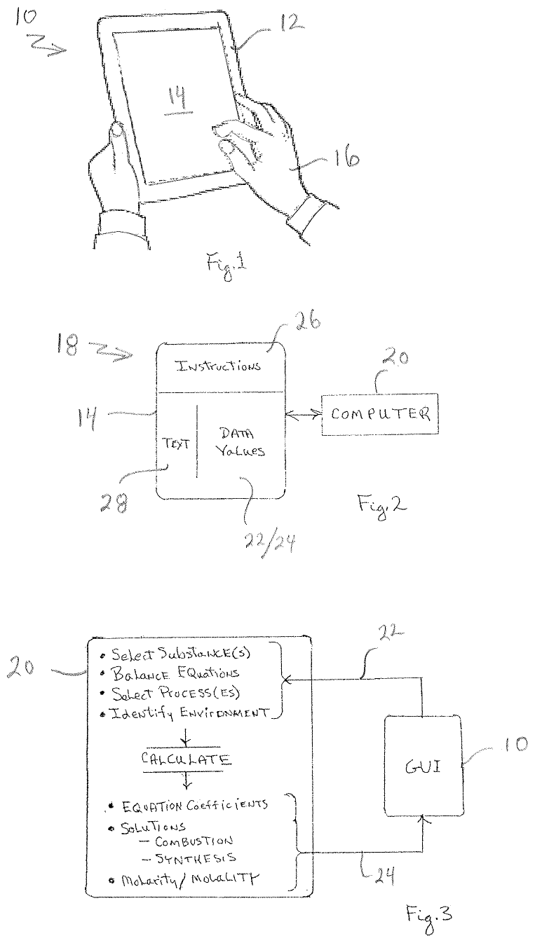

Referring initially to FIG. 1, a Graphical User Interface (GUI) in accordance with the present invention is shown and is generally designated 10. As shown, the GUI 10 includes a base member 12 which supports a graphical chart 14 for visually displaying non-graphical data in an organized graphical presentation. As intended for the present invention, the graphical chart 14 is a touch screen which prompts a user 16 to provide non-graphical input data for a subsequent use in solving chemical equations.

FIG. 2 shows that the present invention is essentially a system which is generally designated 18 and which includes the GUI 10 in combination with a computer 20. In this combination, the GUI 10 and the computer interact with each other by exchanging non-graphical data which is essential for an operation of the system 20. Specifically, the non-graphical data is used to calculate solutions for chemical equations and to create values for the chemical processes that result from reactions based on the chemical equations.

As best appreciated with reference to FIG. 3, non-graphical input data 22 is provided by the user 16 to the computer 20 via the GUI 10. In general, the non-graphical input data 22 will include the selection of at least one chemical substance, such as an element, a compound, an ion, a base or an ester. Additionally, the non-graphical input data 22 will include value units for the selected substance(s) that establish either a quantity or characteristic of each substance. For this purpose, the input data 22 will typically be a number representing moles (i.e weight) or liters of a substance, along with temperature, pressure, and heat information pertinent to the chemical process being evaluated.

Upon receiving the non-graphical input data 22 from the GUI 10, the computer 20 uses the input data 22 for solving and evaluating the chemical process(es) of interest to the user 16. The result here is the generation of non-graphical output data 24 which is then transmitted to the GUI 10. At the GUI 10, the output data 24 is sorted and presented on the graphical chart 14

as a graphical display of the chemical process(es) solved by the computer 20.

Referring again to FIG. 2, it is to be appreciated that an operation of the system 18 will be determined by the instructions 26 that are given to the computer 20 by the user 16. In detail, the instructions 26 include the selection of substances to be evaluated and the implementation of administrative matters such as record-keeping functions. The instructions 26 will also include a procedure for balancing chemical equations and the identification of an environment of interest for the user 16. Further, the instructions 26 will also include the selection of a process or processes to be executed by the computer 20.

As intended for the system, depending on the interest of the user 16 an environment is identified in the instructions 26 as either a laboratory environment, an industrial environment, or a natural environment. Specifically, a laboratory environment can be identified for experimentation purposes. On the other hand, an industrial environment can be identified for industrial and commercial purposes. Alternatively, a natural environment can be identified for description and discovery purposes. For each selection, the non-graphical output data 24 can be uniquely presented on the graphical chart 14 for each environmental identification.

The process(es) selected by the user in the instructions 26 may be classified as either a minor process or a major process. This selection depends on the number of substances involved and calculation requirements of the process. Specifically, a minor process will involve relatively simple and uncomplicated and the complexity of calculations for the molarity or molality of a single specified substance. On the other hand, a major process involves more complicated calculations and computations, such as balancing equations or evaluating the consequences of reactions such as combustion and synthesis involving a plurality of substances.

FIG. 2 also shows that the graphical chart 14 on the GUI 10 includes a section 28 dedicated to text. Specifically, the text presented in section 28 serves several purposes. For one, it assists the user 16 with his/her use of the GUI 10. Another purpose is to provide the user 16 with a general explanation of the process(es) calculated by the computer 20. The text in section 28 will also provide a detailed description and explanation of the chemical process(es) that has(have) been computed.

For an operation of the system 18, it is to be appreciated that the GUI 10 shows non-graphical data that is organized and arranged in a graphical presentation. Specifically, output from the GUI 10 is the non-graphical input data 22 that is input to the computer 20. The non-graphical output data 24 is then provided as input to the GUI 10. The purpose here is to manipulate non-graphical data in a way that gives the user 16 a visual appreciation of the results obtained in a graphical form when a chemical substance is analyzed, or when a reaction of substances occurs in accordance with a chemistry equation.

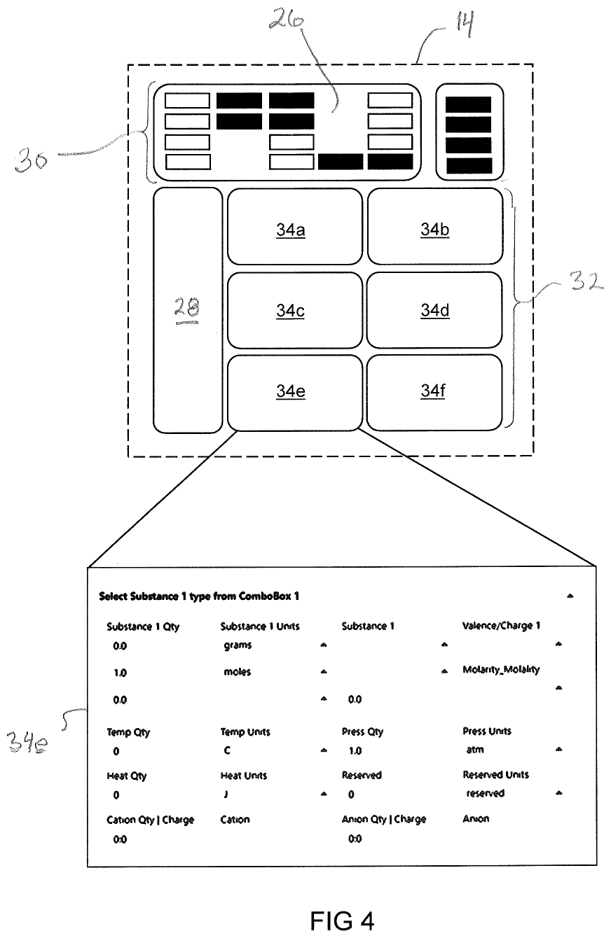

A use of the system 18 is best appreciated with reference to FIG. 4 which shows that the graphic chart 14 of GUI 10 includes an instructions interface 30 and a data interface 32. In detail, the instructions interface 30 gives the user 16 the ability to input the instructions 26 that are needed for an operation of the computer 20. Further, the data interface 32 gives the user 16 the ability to input specific non-graphical input data 22 for selected chemical substances. As shown in FIG. 4, the data interface 32 provides for inputting data for a plurality of different chemical substances to the computer 20 via a respective substance interface 34. The substance interfaces 34a-f are only exemplary, and they can each be used individually or collectively. The enlarged substance interface 34e is shown as an example of the graphical presentation created by the present invention for both inputting non-graphical input data 22 and displaying the resultant non-graphical output data 24 as a solution for chemical substance evaluation or a solution for a chemical reaction.

While the particular invention as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A Graphical User Interface (GUI) for performing computations of chemistry problems and performing related processes which comprises:
a computer programmed to solve predetermined non-graphical chemistry problems and perform related chemical processes;
a calculator interfacing with the computer to provide input data and instructions to the computer for solving the chemistry problems and for performing the related processes, wherein the calculator includes a graphical chart for visually prompting a user to provide the input data and instructions;
a first interface section of the graphical chart for receiving the input data and instructions, and for selecting at least one substance; and
a second interface section of the graphical chart for displaying output values calculated by the computer during implementation of the selected process, to give a solution for the chemistry problems and processes in an organized graphical presentation of the output data.

2. The Graphical User Interface (GUI) of claim 1 wherein the at least one substance-is selected from the group consisting of an element, a compound, an ion, a diatomic and a mixture.

3. The Graphical User Interface (GUI) of claim 1 wherein an equation is selected from the group consisting of a complete molecular equation, a complete ionic equation, and a net ionic equation.

4. The Graphical User Interface (GUI) of claim 1 wherein a plurality of substances is selected by the user.

5. The Graphical User Interface (GUI) of claim 1 further comprising a record keeping unit in the computer for subsequent access to prior solutions by the user.

6. The Graphical User Interface (GUI) of claim 1 wherein the solution is selected from the group consisting of molarity calculations, molality calculations and decomposition of compound calculations.

7. The Graphical User Interface (GUI) of claim 6 wherein the solution includes a plurality of non-graphical values from the output data.

8. A system for performing computations of chemistry problems and related processes which comprises:
a computer means programmed with equations for solving non-graphical chemistry problems and performing related processes to calculate output data;
a first graphical means electronically connected with the computer means for organizing and receiving non-graphical input data and instructions for the computer which are needed to solve the chemistry problems and perform the related processes, wherein the computer calculations generate non-graphical values for the output data which are individually and collectively indicative of the computer calculations; and
a second graphical means electronically connected with the computer means for visually displaying relationships between a plurality of non-graphical values from the output data in an organized graphical presentation thereof to give a solution for the chemistry problems and processes.

9. The system of claim 8 wherein the non-graphical input data includes value units and quantities with which the computer calculates the non-graphical output data for a visual display indicative of the computer calculations.

10. The system of claim 9 wherein the first graphical means and the second graphical means, in combination with each other, create a graphical chart interface by which a user can solve selected chemistry problems and perform related processes.

11. The system of claim 10 wherein the first graphical means is used to prompt the user to provide the non-graphical input data and instructions.

12. The system of claim 11 wherein the user is prompted to identify and select at least one substance for the input data, and wherein the substance is selected from the group consisting of an element, a compound, an ion, a diatomic and a mixture, and further wherein value units for the substances are selected from the group consisting of temperature, pressure, and heat.

13. The system of claim 11 wherein the process is selected from the group consisting of a minor process involving a single process and a major process involving a plurality of processes.

14. The system of claim 8 wherein an equation is selected from the group consisting of a complete molecular equation, a complete ionic equation, and a net ionic equation.

15. A non-transitory, computer-readable medium having executable instructions stored thereon that direct a computer system to perform computations for solving chemistry problems and related processes, the medium comprising instructions for:
programming the computer with equations to solve predetermined non-graphical chemistry problems, and to perform related chemical processes;
receiving input data from a user, wherein the input data includes the identification of at least one chemical substance;
solving the non-graphical chemistry problems and performing the related processes using the input data to generate non-graphical values for calculated output data; and
displaying relationships between a plurality of non-graphical values from the output data in an organized graphical presentation thereof including solutions of the chemistry problems and processes for consideration by the user.

16. The medium of claim 15 further comprising instructions for:
balancing an equation pertinent to the chemistry problem before the receiving instruction requirement; and
verifying the equation is balanced.

17. The medium of claim 15 further comprising instructions for:
introducing an instruction for a quantity change in a substance in the receiving instruction; and
cascading the quantity change through the preprogramed equations before the solving instruction.

18. The medium of claim 15 further comprising instructions for:
creating a record of the solutions of the chemistry problems and processes;
and updating the record.

19. The medium of claim 18 further comprising instruction for:
identifying an environment of interest; and
selecting an identified environment from a group consisting of a laboratory environment, an industrial environment, and a natural environment.

20. The medium of claim 18 further comprising an instruction for selecting a process from the group consisting of a major process involving a plurality of substances and a minor process involving a single substance.
